(19) United States
(12) Patent Application Publication
(10) Pub. No.: US 2013/0335329 A1
(43) Pub. Date: Dec. 19, 2013

(54) COMPUTER INPUT DEVICE

(71) Applicants: Joseph M. Freund, Fogelsville, PA (US); Roger A. Fratti, Mohnton, PA (US)

(72) Inventors: Joseph M. Freund, Fogelsville, PA (US); Roger A. Fratti, Mohnton, PA (US)

(21) Appl. No.: 13/523,140

(22) Filed: Jun. 14, 2012

(51) Int. Cl. G06F 3/02

(52) U.S. Cl. 345/168

(57) ABSTRACT

An apparatus comprising a monitor and a base. The base may be configured to display a plurality of characters received from both a first source within the monitor and a second source. The base may be connected to the monitor through a physical connection and an optical connection. The optical connection may transmit the characters received from the first source within the monitor. The optical connection may use a passive light source derived from a backlight source of the monitor.

### FIELD OF THE INVENTION

The present invention relates to computer input devices generally and, more particularly, to a method and/or apparatus for implementing a laptop input device that may use wasted light from a display backlight.

### BACKGROUND OF THE INVENTION

Conventional laptop computers have a display and a keyboard. The keyboard is used to capture and transmit information from a number of keystrokes typed into the computer. The typed characters are shown on the display. In normal lighting conditions, distinguishing and correctly typing the various characters is not a problem. In low light conditions, it can be difficult to see the keyboard characters, often resulting in the incorrect typing and/or entering of one or more characters. Conventional low light solutions include (1) relying on the ambient light from the display to illuminate the keyboard, (2) turning on an external light source to provide additional illumination or (3) backlighting the keyboard with a light source located in the keyboard. Ambient display light is often not sufficient for very low light situations, or situations that the display is tilted back at an angle greater than 90 degrees. For the case of an external light source, a source may not be readily available or such use would be obstructive to individuals in the vicinity. For keyboards that do provide backlighting of the key characters, a separate light source is used. A separate light source reduces battery life for situations and adds additional manufacturing cost for the piece parts.

Computers with touch screens are becoming more popular. Touch screens can be an alternate way to provide a user interface for entering data, often in addition to a conventional keyboard.

It would be desirable to implement a computer keyboard that may provide a light channel between a display and a keyboard.

### SUMMARY OF THE INVENTION

The present invention concerns an apparatus comprising a monitor and a base. The monitor may be configured to display a plurality of characters received from both a first source within the monitor and a second source. The base may be connected to the monitor through a physical connection and an optical connection. The optical connection may transmit the characters received from the first source within the monitor. The optical connection may use a passive light source derived from a backlight source of the monitor.

The objects, features and advantages of the present invention include providing a computer keyboard and/or monitor that may (i) use light received from a monitor backlight source as a keyboard backlight, (ii) provide an optical connection between a keyboard and a monitor, (iii) transmit data over the optical connection, (iv) provide a directional light source to be unobtrusive and/or (v) use scattered (or wasted) light to avoid a dedicated light source to reduce overall power consumption.

### BRIEF DESCRIPTION OF THE DRAWINGS

These and other objects, features and advantages of the present invention will be apparent from the following detailed description and the appended claims and drawings in which:

FIG. 1 is a diagram of an embodiment of the present invention;

FIG. 2 is an alternate embodiment of the present invention;

FIG. 3 is an alternate embodiment of the present invention;

FIG. 4 is an alternate embodiment of the present invention; and

FIG. 5 is an alternate embodiment of the present invention.

### DETAILED DESCRIPTION OF THE PREFERRED EMBODIMENTS

The present invention may provide a lighting system that may be used to illuminate a keyboard. One example implementation may be a battery powered notebook computer or tablet computer. The illumination may help a user to easily distinguish the keys and/or characters in low and/or very low light conditions (e.g., near complete darkness). The light source may be directionally limited to the keyboard and/or not be obstructive to neighboring individuals. The light source may be implemented without a dedicated light source and/or associated additional costs and/or additional battery drainage.

The lighting system may be built into the base of the laptop display. A light source may provide sufficient illumination to make the characters on a laptop (or notebook) keyboard easily distinguishable, even in very low light environments. In one example, the light system may be directional to illuminate mainly the keyboard, but not other surrounding components that do not need to be illuminated.

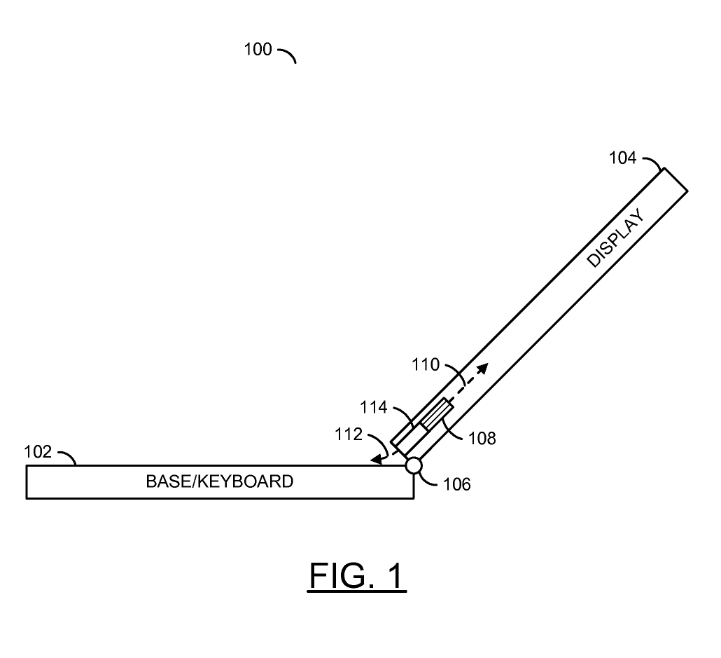

Referring to FIG. 1, a diagram of a computer 100 is shown in accordance with an embodiment of the present invention. The computer 100 generally comprises a section 102 and a section 104. The section 102 may be implemented as a base/keyboard section. In addition to a keyboard, the section 102 may include other components typically used in the base of a notebook computer (e.g., a central processing unit (CPU), other processing circuitry, etc.). The section 104 may be implemented as a monitor (or display). A hinge 106 may connect the base 102 to the monitor 104. A block (or circuit) 108 may be implemented as a backlight section. In one example, the backlight section 108 may be implemented as an LED backlight to the display 104. The LED backlight 108 may also transmit light to the display 104 in a direction marked by an arrow 110. An arrow 112 marks light that may be used to illuminate the keyboard 102. The light in the direction of the arrow 112 may be scattered (or wasted) light that does not get used by the display 104. A block (or circuit) 114 may represent a waveguide. The waveguide 114 may be implemented as a rectangular or cylindrical pipe or tube. The waveguide 114 may be used to focus the scattered light in the direction of the arrow 112.

The waveguide 114 may be used to direct light from the back (or bottom) of the backlight LEDS 108 out the bottom of the display 104. By using the same LED source for both the backlight of the display 104 and to illuminate the keyboard 102, an energy savings may be implemented. In one example, a separate set of one or more LEDs (not shown) may be implemented to provide additional illumination.

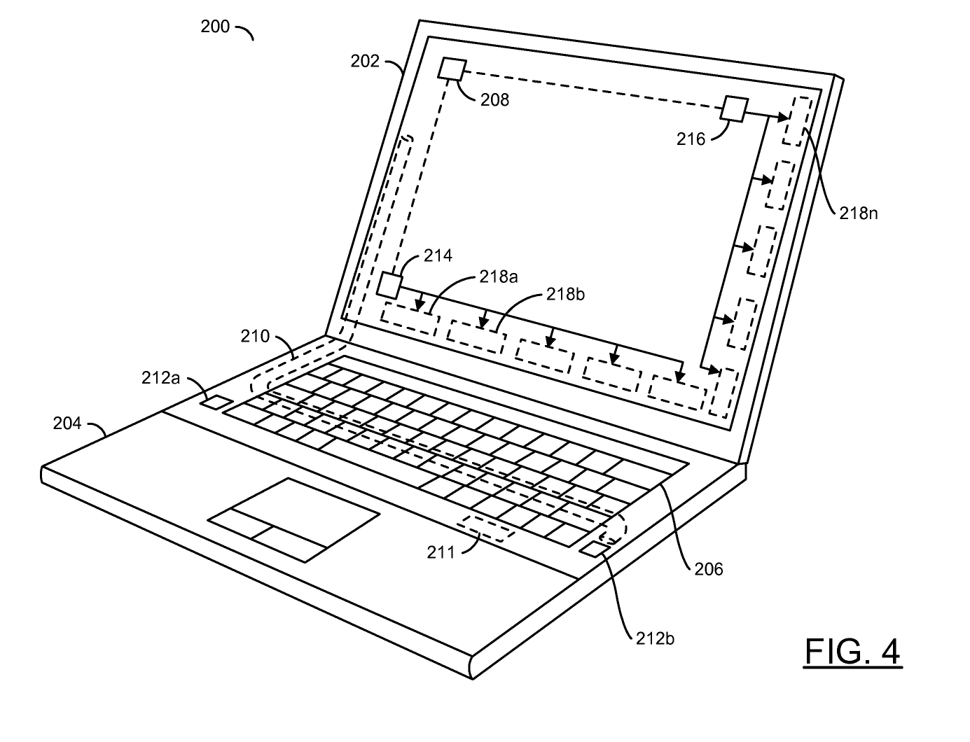

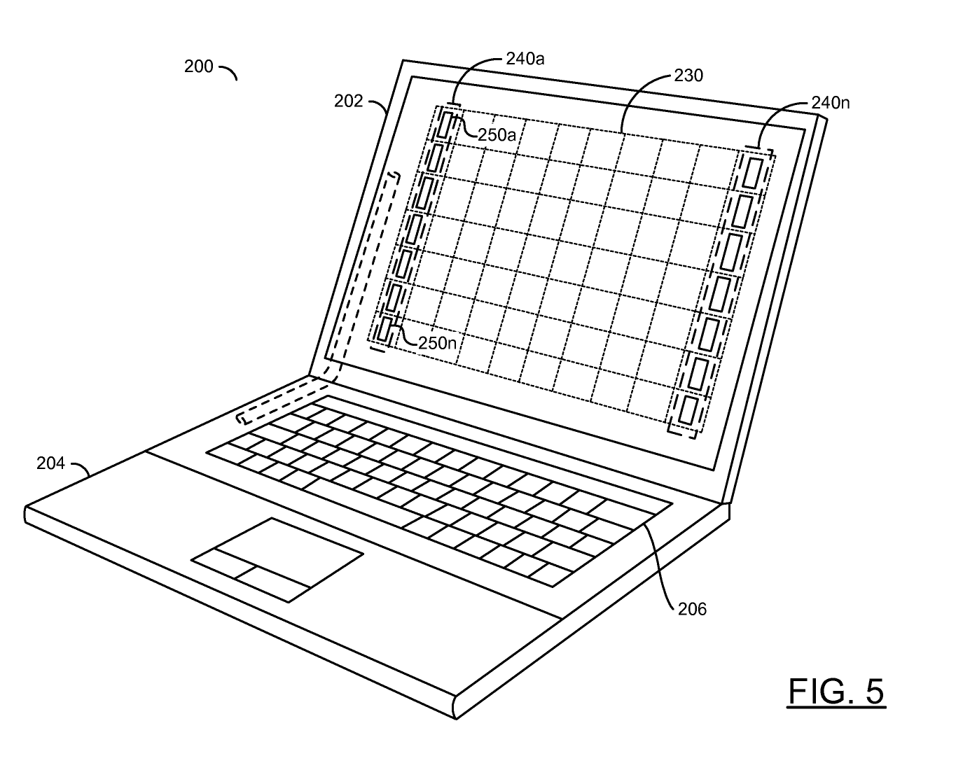

In one example, the computer 100 may use one or more backlight LEDS of the monitor 104. Such backlight LEDs are normally situated along the lower long edge of the display (to be described in more detail in connection with FIGS. 4 and 5). The backlight LEDs may be used to provide backlight for the display 104. Since the backlight LEDs emit light from both the top and bottom (e.g., in a surface emitting device) and from the front and back side (e.g., in an edge emitting device) the light from either the bottom or back of these LEDs may be used to provide illumination for the keyboard 102. The light from the backlight LEDs may be directed via the waveguide structure 114 onto the keyboard surface. In one example, a dimmer key or knob on the keyboard 102 may be incorporated to adjust the level of light presented to the keyboard 102. In another example, a manual attenuator may also be implemented to adjust the illumination and/or intensity of the light. In one example, the waveguide 114 may be designed so that the further the display is tilted away from the keyboard, the more direct the illumination shines onto the keyboard 102. The waveguide 114 may be implemented to provide a particular angle of light in the direction of the arrow 112. The particular angle may be varied to meet the design criteria of a particular implementation.

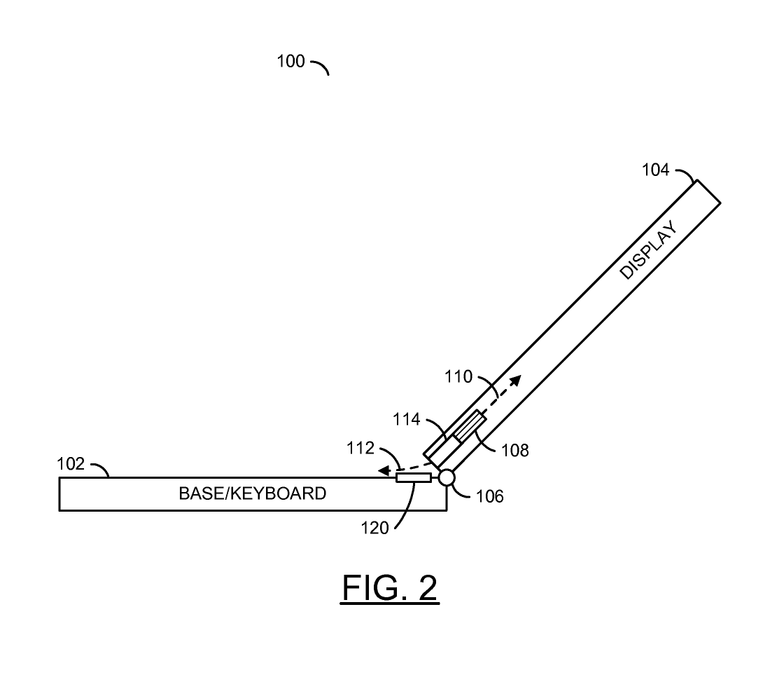

Referring to FIG. 2, an alternate embodiment is shown. In FIG. 2, a reflective element 120 has been added. The reflective element 120 may be used to direct the light 112 in a direction towards the keyboard 102. The reflective element 120 may improve the illuminated light as directed onto the keyboard 102. To further increase the illumination of the keyboard 102, the reflective material 120 may be provided along the top edge of the keyboard 102, thereby reducing the absorption of the light along the top edge of the keyboard 102. In normal light situations, the light from the bottom or back of the backlight display LEDS may be shunted by the mirror 120, turning off the keyboard illumination, thereby increasing the display backlight illumination.

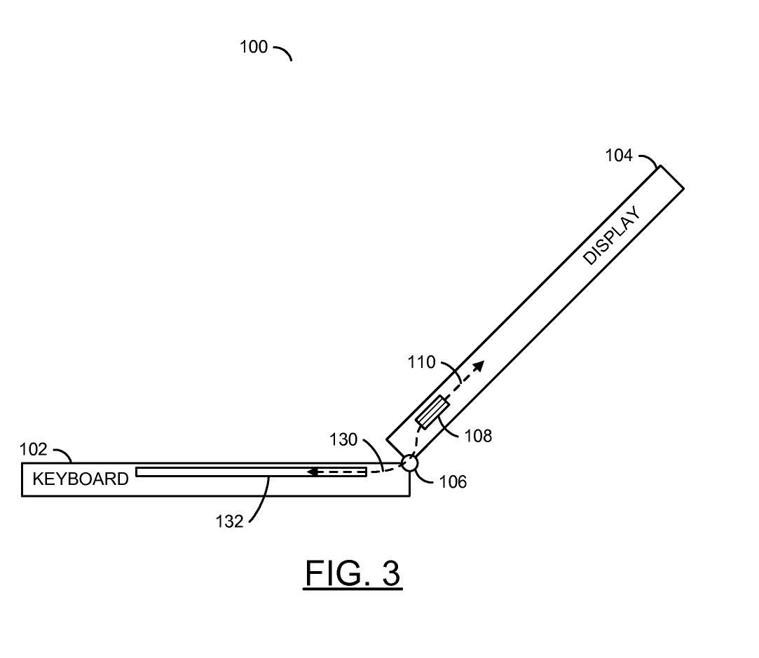

Referring to FIG. 3, an alternate embodiment of the computer 100 is shown. The computer 100 further comprises a light pipe 130 and a lens 132. The light pipe 130 may be implemented, in one example, as a fiber optic cable. However, the particular type of optic cable implemented may be varied to meet the design criteria of a particular implementation. In general, the light pipe 130 may receive light at one end (from the LED backlight 108) and present light both along the length of the light pipe 130 and the end of the light of the light pipe 130. The lens 132 may be implemented, in one example, as a Fresnel lens. Light from the LED backlight 108 may be directed through the light pipe 130 to the lens 132. The lens 132 may spread to light evenly over the surface of the keyboard 102. For example, the lens 132 may distribute the light and/or disperse the light from underneath the keyboard 102. The light pipe 130 may extend from the upper section of the monitor 104 to the lower section of the base/keyboard 102. The lens 132 may provide a broad light panel under the keyboard 102. The particular placement of the light pipe 130 may be varied to meet the design criteria of a particular implementation.

Referring to FIG. 4, a computer 200 is shown in accordance with an alternate embodiment of the present invention. The computer 200 generally comprises a display 202, a base 204, a keyboard 206, a block (or circuit) 208, an optical channel 210, a processor 211, a number of light pickups 212a-212b, a block (or circuit) 214, a block (or circuit) 216, a number of blocks (or circuits) 218a-218n. The circuit 208 may be implemented as a control circuit. The control circuit 208 may be used to control the driver circuits 214 and/or 216. The control circuit 208 may include a processor and/or a memory. The processor of the control circuit 208 may read computer instructions that, when executed, perform one or more control functions. The circuit 214 and/or the circuit 216 may be implemented as driver circuits. The circuits 218a-218n represent the LED backlight elements. The optical channel 210 may be connected between the display 202 and the base 204. A number of light pickups 212a-212b may be implemented. The light pickups 212a-212b may be used to sense modulated light within the light pipe 210. In one example, one or more of the backlight LEDs 218a-218n may be dedicated to providing light to the keyboard 206. The dedicated backlight LEDs 218a-218n may be separate devices configured to provide independent illumination control, positioning and/or design freedom.

Referring to FIG. 5, a more detailed diagram of the computer 200 is shown. The display 202 is shown comprising an overlay 230. The overlay 230 may include a number of sensor elements 240a-240n. The sensor element 240a is shown comprising a number of individual sensors 250a-250n. The particular number of sensor elements 240a-240n and the particular number of the individual sensors 250a-250n may be varied to meet the design criteria of a particular implementation.

The constant current source drivers 214 and/or 216 may drive the lighting elements 218a-218n based on a pulse amplitude modulation (PAM) brightness control signal received from the circuit 208. The touch screen overlay system 230 may detect a physical touch on the display 202. A character (or character information) may be transmitted to a pulse phase modulator (PPM) inside the circuit 208. The circuit 208 may modify the light pulses from the LED backlights 218a-218n based on a desired modulation. The modulation may allow the light pulses to include the character information.

A “character” may include a variety of “chunks” of data. For example, a character may include information that is encoded from the touch display overlay 230 and/or used to generate the PPM signal for transmission to the detectors 212a-212n. The characters may include ANSI (or ASCII) characters, positional information related to the touch screen, events such as finger down/up, lack of events for dimming or timing out of the display brightness, etc. The particular type of information transmitted as character information may be varied to meet the design criteria of a particular implementation.

The character information may be generated by changing the rate of pulses to generate a serial data stream (or serial information). The rate the pulses change is fast enough to not be noticed when viewing the display 202. The modulated light is normally transmitted by the light pipe 210. The main body 204 may also include photodetectors 212a-212n. The photodetectors 212a-212n may decode a serial information signal containing the character information.

The computer 200 may provide a communication link that may use light from the display 202 to communicate the character information to other parts of the computer 200. For example, the touch screen overlay 230 may sense the position of a touch. The sensors 250a-250n may be positioned around the perimeter of the overlay 230. The sensors 250a-250n may process the touch information to be interpreted and/or used by the computer 200. For example, the computer 200 may use touch information from the sensors 250a-250n to be encoded with the pulse phase modulator of the circuit 208. This essentially maps information to phases of a pulse stream. The character information is generally contained in the phase of the pulses and not the amplitude.

The back light for the display 202 may be controlled by pulse amplitude modulation (PPM) of the power supply. For example, to make the display 202 brighter the pulse amplitude may be increased. To make the display 202 darker, the pulse amplitude may be decreased. Changing the pulse amplitude modulation may be a technique to alter the brightness of the display 202. The constant current source drivers 214 and/or 216 may implement the PAM brightness control. The drives 214 and/or 216 control the peripheral LED backlights 218a-218n. The wasted light (or even dedicated light) sent into the light pipe 210 may provide changes in brightness of the monitor 202 as the amplitudes changes.

The computer 200 may use a PAM signal to be generated and/or modified by the circuit 208. The circuit 208 may provide the phase modulated portion of a signal containing the desired touch character information. In general, the pulse phase of the PAM is changing. The character information may be sent independently of the brightness level of the display 202. The desired character information may be embedded into one or more phases of the light used for backlighting. In one example, the character information may be a high level or low level pulse. Similar to an FM modulated signal, the strength of the character information may become weaker as the distance from the source increases. The character information may still be received as the signal level drops. For example, the information in the PAM and/or PPM signals is orthogonal.

The particular placement of the photodetectors 212a-212b may be varied. The photodetector 212a-212n may be placed somewhere in the base 204, under the lens 132. Since the lens 132 spreads the light, the particular placement of the photodetectors 212a-212n may be varied to meet the design criteria of a particular implementation. The photodetectors 212a-212n normally receive the phase modulated light pulses. In general, the detected light may be used as a carrier. The phase position of the pulses may convey the character information. The character information may then be processed by the processor 211 to provide a reaction to touch information (e.g., close files, zoom in, zoom out, etc).

The functions performed by the circuit 208 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. An apparatus comprising:
a monitor configured to display a plurality of characters received from both a first source within said monitor and a second source; and
a base connected to said monitor through a physical connection and an optical connection, wherein (A) said optical connection transmits said characters received from said first source within said monitor, and (B) said optical connection uses a passive light source derived from a backlight source of said monitor.

2. The apparatus according to claim 1, wherein said backlight source comprises a light emitting diode (LED) backlight source.

3. The apparatus according to claim 2, wherein said LED backlight source uses scattered light not presented to said display to provide said passive light source to said optical connection.

4. The apparatus according to claim 1, wherein said monitor and said base are further connected by electrical connection configured to present information from a keyboard in said base to said display.

5. The apparatus according to claim 1, wherein said base further comprises a keyboard and a central processing unit (CPU).

6. The apparatus according to claim 1, wherein said monitor comprises a plurality of touchscreen sensors configured to generate characters from said first source.

7. The apparatus according to claim 1, wherein said first source generates said characters over said optical connection by a pulse phase modulation signal sent over said optical connection.

8. The apparatus according to claim 7, wherein said base comprises a photo diode configured to read said pulse phase modulation signal from said optical connection.

9. The apparatus according to claim 8, wherein said base comprises a plurality of said photo diodes and said base uses a best one of said photo diodes to generate said characters.

10. The apparatus according to claim 1, wherein said optical connection generates said characters from said first source and provides a backlighting to a keyboard in said base.

11. The apparatus according to claim 10, wherein said backlight is presented from an underside of said keyboard.

12. The apparatus according to claim 10, wherein said backlighting is provided from a top of said keyboard.

13. The apparatus according to claim 12, further comprising a mirror configured to adjust an angle backlighting.

14. The apparatus according to claim 10, further comprising a lens configured to disperse said backlighting over an area of said keyboard.

15. An apparatus comprising:
means for displaying a plurality of characters received from both a first source within said monitor and a second source; and
means for connecting to a monitor through to said means for displaying through a physical connection and an optical connection, wherein (A) said optical connection transmits said characters received from said first source, and (B) said optical connection uses a passive light source derived from a backlight source of said monitor.

16. A method for connecting an input device to a processor, comprising the steps of:
displaying a plurality of characters received from both a first source within said monitor and a second source; and
connecting a base through a physical connection and an optical connection to a display, wherein (A) said optical connection transmits said characters received from said first source within said display, and (B) said optical connection uses a passive light source derived from a backlight source of said display.
